(19) United States
(12) Patent Application Publication
(10) Pub. No.: US 2013/0235452 A1
(43) Pub. Date: Sep. 12, 2013

(54) ANTI-FOGGING OPTICAL FILTERS AND IR BLOCKING ASSEMBLIES, AND METHODS FOR FABRICATING SAME

(71) Applicants: Xiaorong You, Shrewsbury, MA (US); Jonathan M. Boulton, North Attleboro, MA (US)

(72) Inventors: Xiaorong You, Shrewsbury, MA (US); Jonathan M. Boulton, North Attleboro, MA (US)

(73) Assignee: HONEYWELL INTERNATIONAL INC., Morristown, NJ (US)

(21) Appl. No.: 13/418,231

(22) Filed: Mar. 12, 2012

(51) Int. Cl. G02B 13/14; B32B 37/14; B32B 38/08

(52) U.S. Cl. 359/356; 156/278

(57) ABSTRACT

Optical filters, infrared (IR) blocking assemblies, and methods for fabricating optical filters are provided herein. In an embodiment, an optical filter includes a transparent base lens having a first surface and a second surface. The optical filter includes an anti-fogging layer as an outermost layer connected to the first surface of the base lens. Further, an infrared (IR) blocking film is bonded to the second surface of the base lens. The IR blocking film includes reflective layers configured to transmit no more than about 40% of IR light.

### TECHNICAL FIELD

The present disclosure generally relates to optical filters and infrared (IR) blocking assemblies, and methods for fabricating optical filters and IR blocking assemblies, and more particularly relates to optical filters and IR blocking assemblies with improved IR blocking and anti-fogging properties.

### BACKGROUND

Some industrial processes generate intense light that require eye protection. For example, during welding the welder's torch and the heated metal can both emit harmful luminous, infrared, and ultraviolet light. In order to provide safe working conditions, various safety standards have been enacted for industrial eye and face protection for welding and other activities. Typically the standards define set of shade ratings based on the weighted transmittance of far ultraviolet (200 nm-315 nm), near ultraviolet (315 nm-380 nm), luminous (380 nm-780 nm), infrared (780 nm-3000 nm) and blue (400 nm-700 nm) light. Different minimums of shade protection are recommended for gas welding, cut welding, or torch brazing.

A welding operator typically wears dedicated eye protection such as a helmet, mask, or goggles when working with harmful light emissions. Often, the dedicated eye protection has a small viewing area formed from an optical filter and provides only a limited range of vision. Further, the dedicated optical filter may be too dark for general wear. Due to the limitations and discomfort of the eye protection, operators frequently remove the eye protection when not performing an operation with harmful light emission.

Conventional eye protection uses shields or goggles formed from injection molded resins that incorporate IR absorbing dyes. However, high temperatures are required during injection molding of these resins, and it is necessary that the IR absorbing dyes have thermal stability at the high temperatures. Further, due to the partial decomposition of dyes during injection molding, a large amount of extra dye must be used to ensure proper protection against IR emissions.

Other eye protection devices have used metalized films to reflect IR light. However, the high reflective nature of metalized films in the visible spectrum limits their industrial applicability. Further, eye protection with such metalized films is often not affordable. Also, metalized films typically cannot be used in hot and highly humid working conditions without the aid of anti-fogging devices.

Accordingly, it is desirable to provide optical filters that have superior IR blocking. In addition, it is desirable to provide optical filters that have anti-fogging properties. It is also desirable to provide a method for manufacturing optical filters with sufficient IR blocking and anti-fogging characteristics. Furthermore, other desirable features and characteristics of the optical filters, IR blocking assemblies and methods of fabrication will become apparent from the subsequent detailed description and the appended claims, taken in conjunction with the accompanying drawings and this background.

### BRIEF SUMMARY

Optical filters, infrared (IR) blocking assemblies, and methods for fabricating optical filters are provided herein. In one exemplary embodiment, an optical filter includes a transparent base lens having a first surface and a second surface. The optical filter includes an anti-fogging layer connected to the first surface of the base lens. Further, an infrared (IR) blocking film is bonded to the second surface of the base lens. The IR blocking film includes reflective layers configured to transmit no more than about 50% of IR light, i.e., light having wavelengths of 780 nm to 1400 nm.

In another exemplary embodiment, an IR blocking assembly is provided for application to a lens. The IR blocking assembly includes an anti-fogging layer configured for application to a first surface of the lens. Further, the IR blocking assembly includes a plurality of reflective layers arranged to transmit no more than about 50% of IR light and more than about 40% luminous light. The plurality of reflective layers is configured for application to a second surface of the lens.

In a further exemplary embodiment, a method for fabricating an optical filter is provided. The method includes providing a transparent base lens having a first surface and a second surface. An anti-fogging layer is connected to the first surface of the transparent base lens. Further, an IR blocking film is prepared with a stack of reflective layers configured to transmit no more than about 20% of IR light. The IR blocking film has a first surface and a second surface. The method includes applying a hardcoat to the second surface of the IR blocking film. Further, the method includes bonding the first surface of the IR blocking film to a second surface of the transparent base lens. The optical filter is configured to transmit more than 40% luminous light.

### BRIEF DESCRIPTION OF THE DRAWING

Exemplary embodiments will hereinafter be described in conjunction with the following drawing figures, wherein like numerals denote like elements, and wherein:

FIG. 1 is a perspective view of an optical filter as used in protective eyewear in accordance with an exemplary embodiment;

FIG. 2 is a cross sectional view of the optical filter of FIG. 1;

FIG. 3 is cross sectional view of an alternative embodiment of the optical filter of FIGS. 1 and 2 in accordance with an exemplary embodiment; and

FIG. 4 is a cross sectional view of an IR blocking film used in the optical filters of FIGS. 2 and 3, in accordance with an exemplary embodiment.

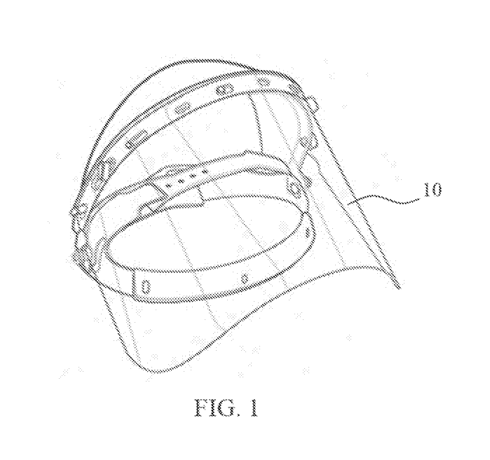

### DETAILED DESCRIPTION

The following Detailed Description is merely exemplary in nature and is not intended to limit the optical filters, IR blocking assemblies, or methods of fabrication claimed herein. Furthermore, there is no intention to be bound by any theory presented in the preceding Background or the following Detailed Description.

The various exemplary embodiments contemplated herein are directed to optical filters, IR blocking assemblies, and methods of fabrication. While specific reference is made herein to use of optical filters and IR blocking assemblies for protective eyewear, other applications such as on windows are contemplated.

In the optical filters and IR blocking assemblies, a plurality of reflective IR blocking layers are incorporated. The IR blocking layers cooperate to reflect and destruct light in the manner of an etalon or interferometer. As a result, the reflective IR blocking layers are configured to transmit no more than about 50% of IR light—for example, no more than 20% of IR light, or no more than 10% of IR light. At the same time, the IR blocking layers transmit more than 40% of incident luminous light (i.e., light having wavelengths of 380 nm to 780 nm, such as more than 66% of incident luminous light.

Exemplary reflective IR blocking layers can be configured to transmit no more than about 20% of IR average transmission (e.g., as defined in EN Standard 166). It is contemplated that the reflective IR blocking layers be selected, designed, and arranged to limit the reduction of IR transmission to a specific range of IR light, such as 780 nm to 1400 nm, or could be limited to a larger range including wavelengths spanning beyond the IR range, such as 780 nm to 3000 nm. Additionally, the IR blocking layers can be designed to have a very low IR transmission, e.g., <0.01% (optical density of 4) which is applicable for blocking specific laser light in the IR region. Further, the optical filter employing the exemplary reflective IR blocking layers transmits more than 40% luminous light.

In the exemplary embodiment, the optical filter 10 is shown in use as protective eyewear such a face shield that can be worn over a helmet or without a helmet. While illustrated as a face shield, the optical filter 10 may be protective eyewear in the form of goggles or a mask, or another article such as window in a structure, a vehicle window, or other transparent member.

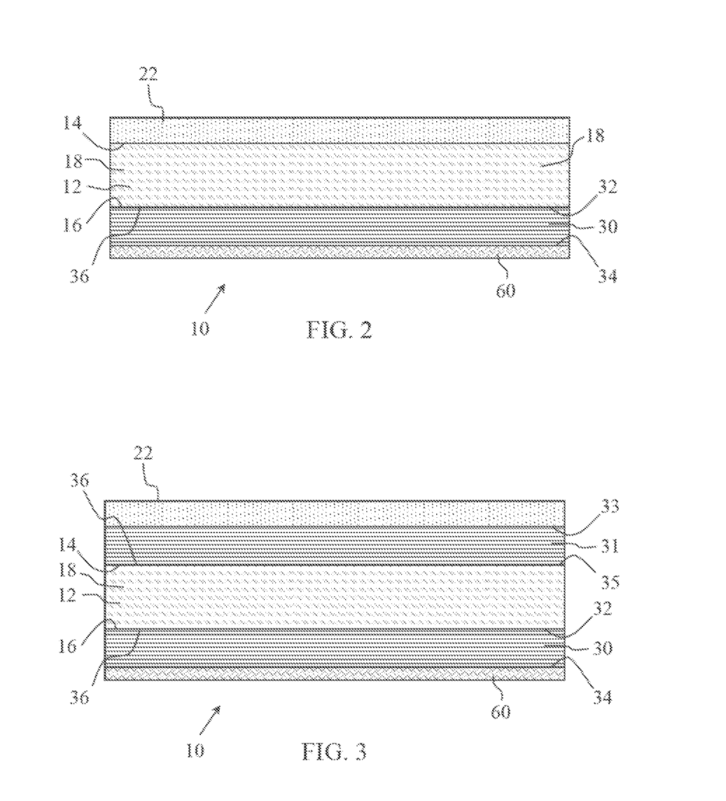

FIG. 2 is a not-to-scale illustration of the components of the optical filter 10. As shown, the optical filter 10 includes a base lens 12, such as a polymeric lens. The lens can have any size or shape as is suitable for a desired application but generally has a first surface 14 and a second surface 16. While the base lens 12 may be formed from any transparent polymeric material conventionally used for lenses, a preferred material is polycarbonate. Further, the exemplary base lens 12 includes an ultraviolet (UV) stabilizer or absorber 18. The UV absorber 18 is typically incorporated into the polycarbonate before or during molding and is integral in the base lens 12. UV absorbers work by absorbing the UV radiation and preventing the formation of free radicals. The specific absorber 18 and amount of absorber 18 may be selected to match the desired UV absorption spectrum. Concentrations of the UV absorber 18 in the base lens 12 normally range from 0.05 vol. % to 2 vol. %, with some applications up to 5 vol. %. Typical UV absorbers suitable for use with polycarbonate are benzotriazoles and hydroxyphenyltriazines.

In the exemplary optical filter 10, an anti-fogging layer 22 is formed on the first surface 14. Fogging is a term used to describe the formation of small discrete droplets of water on the surface of transparent films. Fogging most commonly occurs when there is a temperature differential between the inside and the outside of an enclosed atmosphere causing localized cooling at the interface. The anti-fogging layer 22 can change the interfacial tension between water and the surface of the optical filter 10 allowing the condensed water droplets to spread into a continuous and uniform transparent layer on the fabricated film. The anti-fogging layer 22 may comprise a photocatalytic film such as a titanium oxide film, a film formed from an acyl group-containing composition, or stable superhydrophilic coatings including nanoparticles, polyelectrolytes, or a combination of these. Generally, any of the well-known anti-fogging materials may be used as long as they do not substantially interfere with luminous light transmittance.

As shown in FIG. 2, an IR blocking film 30 is bonded to the second surface 16 of the base lens 12. The IR blocking film 30 includes a first surface 32 and a second surface 34. As shown, the first surface 32 is bonded to the second surface 16 of the base lens 12. In certain embodiments, the IR blocking film 30 is bonded to the base lens 12 with an adhesive 36, such as a pressure sensitive adhesive. Alternatively or additionally, the IR blocking film 30 is heat laminated to the base lens 12.

FIG. 3 is a not-to-scale cross-sectional drawing of an alternative embodiment of the optical filter 10. As shown, the optical filter 10 includes a base lens 12, such as a polymeric lens. The lens can have any size or shape as is suitable for a desired application but generally has a first surface 14 and a second surface 16. While the base lens 12 may be formed from any transparent polymeric material conventionally used for lenses, a preferred material is polycarbonate. Further, the exemplary base lens 12 includes a UV stabilizer or absorber 18.

In FIG. 3, an IR blocking film 31 is bonded to the first surface 14 of the base lens 12. The IR blocking film 31 includes a first surface 33 and a second surface 35. As shown, the second surface 35 is bonded to the first surface 14 of the base lens 12. In certain embodiments, the IR blocking film 30 is bonded to the base lens 12 with an adhesive 36, such as a pressure sensitive adhesive. Alternatively or additionally, the IR blocking film 31 is heat laminated to the base lens 12.

In the exemplary optical filter 10, an anti-fogging layer 22 is formed on the first surface 33 of the IR blocking film 31. As indicated above, the anti-fogging layer 22 may comprise a photocatalytic film such as a titanium oxide film, a film formed from an acyl group-containing composition, or stable superhydrophilic coatings including nanoparticles, polyelectrolytes, or a combination of these. Generally, any of the well-known anti-fogging materials may be used as long as they do not substantially interfere with luminous light transmittance.

The optical filter 10 of FIG. 3 further includes an IR blocking film 30 bonded to the second surface 16 of the base lens 12. The IR blocking film 30 includes a first surface 32 and a second surface 34. As shown, the first surface 32 is bonded to the second surface 16 of the base lens 12. In certain embodiments, the IR blocking film 30 is bonded to the base lens 12 with an adhesive 36, such as a pressure sensitive adhesive. Alternatively or additionally, the IR blocking film 30 is heat laminated to the base lens 12.

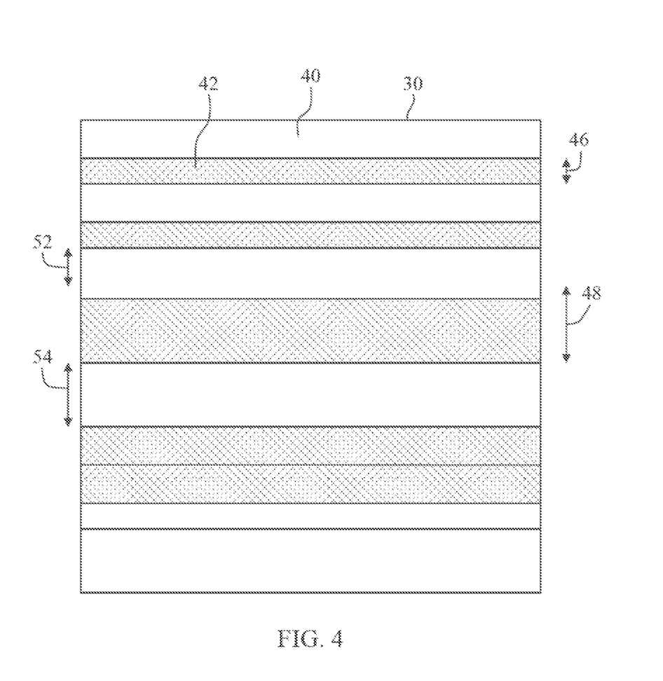

FIG. 4 is a not-to-scale illustration of the IR blocking film 30, which is shown to include reflective layers 40 that are configured to transmit only a desired amount of incident IR light. The reflective layers 40 may be ceramic and can include ceramic nitride or ceramic oxide layers. Exemplary reflective layers 40 include non-metalized non-oxide layers, such as non-metalized titanium nitride layers. As shown, the reflective layers 40 may be separated from one another by spacing layers 42, such as non-metal spacing, protective, structural, or slip agent layers, such as polyethylene terephthalate, positioned between reflective layers 40. Alternatively, the reflective layers 40 may be adjacent one another. Depending on the desired IR blocking function, the reflective layers 40 can be spaced by varied distances, such as by distances 46 and 48. Further, the reflective layers 40 can have varied thicknesses, such as thicknesses 52 and 54. In an exemplary embodiment, each reflective layer has thickness of about 10 nm to about 10 mil.

The reflective layers 40 are selected and arranged to perform as an interference filter to reflect or block IR light while allowing luminous light to pass through. Specifically, the reflective layers 40 are distanced from one another to create IR light interference, such that the IR blocking film 30 transmits no more than about 10% of IR light while transmitting more than about 40% of luminous light incident on the IR blocking film 30. Generally, the composition and thickness of each layer 40 determines what wavelengths of light are reflected and what wavelengths pass through. Therefore, the layers may be optimized to block the IR light while transmitting luminous light.

As shown in FIGS. 2 and 3, one or more protective layers may be located on the second surface 34 of the IR blocking film 30 to increase the durability or the IR blocking region and intensity of the optical filter 10. For example, the protective layers may include a scratch resistant hardcoat layer 60. The hardcoat layer 60 may be a silica-based hardcoat, a siloxane hardcoat, a melamine hardcoat, an acrylic hardcoat, or a similar material.

In an exemplary fabrication process, the base lens 12 is molded from polycarbonate and a UV absorber into the desired shape. The anti-fogging layer 22 is formed on the first surface 14 of the base lens 12, such as by lamination. Further, the IR blocking film 30 is prepared with a stack of reflective layers configured to transmit no more than about 20% of IR light. The IR blocking film is bonded to the base lens. Further, the hardcoat layer is coated onto the IR blocking film and cured.

EXAMPLE: A lens film mounted on the base lens, the lens film comprising: one or more non metalized layers (titanium nitride layers), being arranged in a stack to provide eye protection appropriate for IR protection, high visible transmission and neutral color; the lens film can be mounted on the base lens by a variety of methods including using pressure sensitive and permanent adhesives or by lamination using thermoplastic films; one or more anti-fog layers disposed over at least one face of the stack of non metalized layers or the lens substrate on the opposite face of the stack of non metalized layers; and an ultraviolet light absorbing material disposed in the lens film or base lens. For example, an IR protective faceshield was constructed as follows: A clear, flat polycarbonate faceshield was precoated with anti-fog coating on the first surface and was cleaned on the second surface. An IR blocking film (for example, Huper Sieben available from Huper Optik) was cut to size. This film is titanium nitride based and is coated on one-side with pressure sensitive adhesive. The protective backing film was then removed from the Huper Sieben film which was then laminated to the second surface of the clear polycarbonate faceshield.

When tested, the exemplary laminated faceshield had high visible light transmission with good IR blocking properties. The luminous transmittance was 69.3% and the IR transmittance was 8.2% when tested to the ANSI Z87 standard and had anti-fogging performance.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the claimed optical filter, IR blocking assembly, or method for fabrication in any way.

Rather, the foregoing detailed description will provide those skilled in the art with a convenient road map for implementing an exemplary embodiment of the claimed optical filter, IR blocking assembly, or method for fabrication. It being understood that various changes may be made in the function and arrangement of elements described in an exemplary embodiment without departing from the scope of the optical filter, IR blocking assembly, or method for fabrication as set forth in the appended claims.

What is claimed is:

1. An optical filter comprising:
a transparent base lens having a first surface and a second surface;
an anti-fogging layer as an outermost layer to the first surface of the base lens;
an infrared (IR) blocking film bonded to the second surface of the base lens, wherein the IR blocking film includes reflective layers configured to transmit no more than about 50% of IR light.

2. The optical filter of claim 1 wherein the IR blocking film has a first surface and a second surface, and wherein the first surface of the IR blocking film is bonded to the base lens, and further comprising a scratch resistant hardcoat formed on the second surface of the IR blocking film.

3. The optical filter of claim 2 wherein the scratch resistant hardcoat is selected from the group comprising a silica-based hardcoat, a siloxane hardcoat, a melamine hardcoat, and an acrylic hardcoat.

4. The optical filter of claim 1 wherein the IR blocking film is laminated to the base lens.

5. The optical filter of claim 4 further comprising an adhesive between the IR blocking film and the base lens.

6. The optical filter of claim 1 wherein each reflective layer has thickness of about 10 nm to about 10 mil.

7. The optical filter of claim 1 wherein the reflective layers include ceramic layers, non-metalized non-oxide layers, non-metalized titanium nitride layers, ceramic nitride or ceramic oxide layers.

8. The optical filter of claim 1 wherein the reflective layers are distanced from one another to create IR light interference, wherein the reflective layers are configured to transmit no more than about 10% of IR light, and wherein the optical filter transmits more than about 66% luminous light.

9. The optical filter of claim 1 further comprising a plurality of IR blocking films bonded between the anti-fogging layer and the base lens.

10. The optical filter of claim 9 wherein the transparent base lens is polycarbonate and wherein the UV light absorber is formed from benzotriazoles and/or hydroxyphenyltriazines.

11. An infrared (IR) blocking assembly for application to a lens comprising:
an anti-fogging layer configured for application to a first surface of the lens; and
a plurality of reflective layers arranged to transmit no more than about 50% of IR light and more than about 50% luminous light, wherein the plurality of reflective layers is configured for application to a second surface of the lens.

12. The IR blocking assembly of claim 11 wherein the plurality of reflective layers form a first surface for application to the second surface of the lens and a second surface, and further comprising a scratch resistant hardcoat formed on the second surface of the plurality of reflective layers.

13. The IR blocking assembly of claim 12 wherein the scratch resistant hardcoat is selected from the group comprising a silica-based hardcoat, a siloxane hardcoat, a melamine hardcoat, and an acrylic hardcoat.

14. The IR blocking assembly of claim 11 wherein the reflective layers include ceramic layers, non-metalized non-oxide layers, non-metalized titanium nitride layers, ceramic nitride or ceramic oxide layers.

15. The IR blocking assembly of claim 11 wherein the reflective layers are distanced from one another to create IR light interference, wherein the reflective layers are configured to transmit no more than about 10% of IR light, and more than about 66% luminous light.

16. The IR blocking assembly of claim 11 wherein the reflective layers are distanced from one another to create IR light interference, and wherein the reflective layers are configured to transmit no more than about 20% of IR light and more than about 66% luminous light.

17. The IR blocking assembly of claim 11 wherein the reflective layers are distanced from one another to create IR light interference, and wherein the reflective layers are configured to transmit no more than about 30% of IR light and more than about 66% luminous light.

18. The IR blocking assembly of claim 11 wherein the reflective layers are distanced from one another to create IR light interference, and wherein the reflective layers are configured to transmit no more than about 10% of IR light and more than about 50% luminous light.

19. The IR blocking assembly of claim 14 wherein the reflective layers are distanced from one another to create IR light interference, and wherein the reflective layers are configured to transmit no more than about 10% of IR light and more than about 40% luminous light.

20. A method for fabricating an optical filter comprising:
providing a transparent base lens having a first surface and a second surface;
connecting an anti-fogging layer as an outermost layer to the first surface of the transparent base lens;
preparing an infrared (IR) blocking film with a stack of reflective layers configured to transmit no more than about 20% of IR light, wherein the IR blocking film has a first surface and a second surface;
applying a hardcoat to the second surface of the IR blocking film;
bonding the first surface of the IR blocking film to a second surface of the transparent base lens, wherein the optical filter is configured to transmit more than 40% luminous light.
